(19) United States
(12) Patent Application Publication
(10) Pub. No.: US 2024/0393460 A1
(43) Pub. Date: Nov. 28, 2024

(54) SYSTEM AND METHOD FOR OBJECT DETECTION

(71) Applicant: HUAWEI TECHNOLOGIES CO., LTD., Shenzhen (CN)

(72) Inventors: Ali Ahmed Ali MASSOUD, Kanata (CA); Zhiping JIANG, Kanata (CA); Hongbiao GAO, Shenzhen (CN)

(21) Appl. No.: 18/794,372

(22) Filed: Aug. 5, 2024

Related U.S. Application Data
(63) Continuation of application No. PCT/CN2022/080573, filed on Mar. 14, 2022.

(51) Int. Cl. G01S 17/04; G01S 7/4861; G01S 7/487

(52) U.S. Cl. CPC G01S 17/04; G01S 7/4861; G01S 7/4873; G01S 7/4876

(57) ABSTRACT

The disclosed LiDAR systems and methods are for object detection. The LiDAR system for object detection comprising: i) a receiver configured to receive a light signal reflected from an object; ii) a digital converter configured to convert the received light signal into a digital signal; iii) a pre-processor configured to pre-process the digital signal based on median filtering and to generate a pre-processed signal corresponding to the digital signal; and iv) a processor configured to analyze the pre-processed signal based on a threshold technique to detect a presence of the object.

### CROSS REFERENCE

The present application claims priority to International Application No. PCT/CN2022/080573, filed on Mar. 14, 2022, entitled “System and Method of Object Detection, which is incorporated by reference herein in its entirety.

### TECHNICAL FIELD

The present disclosure generally relates to the field of LiDAR systems and, in particular, to systems and methods for object detection.

### BACKGROUND

Typically, object-detection systems such as light imaging detection and ranging (LIDAR) systems comprise a receiver configured to process the light signals. These light signals are transmitted by a transmitter usually synchronized with the receiver. The interaction between an object and the transmitted light signal produces an echo and the receiver is configured to receive and decode such echoes from the objects. The receiver uses several variables to decode the echoes, such variables include the delay between the transmitted light signal and the arrival of the echo reflected by the object, the strength of the received echo, etc.

Even though, typical LiDAR systems have been widely used in various automotive applications for object detection, the performance of such typical LiDAR systems degrade significantly in adverse weather conditions, such as, for example, fog, rain, dust cloud or the like. Adverse weather conditions introduce two main challenges to LiDAR automotive detection applications, namely, severe signal attenuation at long ranges and false alarms caused at short ranges.

Various conventional techniques have been proposed to improve the degraded performance of the typical LiDAR systems. Such techniques are based on curve fitting or Convolutional Neural Networks that require prior identification of adverse weather conditions. These conventional techniques are computationally expensive and require large processing memories. Additionally, these conventional techniques cause significant errors in the event of wrongly identifying the adverse weather conditions.

With this said, there is an interest in developing LiDAR based systems and methods for efficiently and accurately identifying and locating objects in adverse weather conditions.

### SUMMARY

The embodiments of the present disclosure have been developed based on developers' appreciation of the limitations associated with the prior art. Typically, a performance of a typical LiDAR system degrades significantly in adverse weather conditions. Various conventional techniques are based on curve fitting or Convolutional Neural Networks that require prior identification of adverse weather conditions. These conventional techniques suffer from a heavy computational load on the processors associated with the typical LiDAR system and require large processing memories. Additionally, these conventional techniques cause significant errors in the event of wrongly identifying the correct adverse weather conditions.

Developers of the present technology have devised methods and systems for efficiently detecting objects with reduced computational load on the processors associated with the typical LiDAR system.

In accordance with a first broad aspect of the present disclosure, there is provided a LiDAR system for object detection comprising: a receiver configured to receive a light signal reflected from an object; a digital converter configured to convert the received light signal into a digital signal; a pre-processor configured to pre-process the digital signal based on median filtering and to generate a pre-processed signal corresponding to the digital signal; and a processor configured to analyze the pre-processed signal based on a threshold technique to detect a presence of the object.

In accordance with any embodiments of the present disclosure, the pre-processor comprises: a median filter configured to perform median filtering of the digital signal and generate a filtered digital signal; and a subtractor configured to subtract the filtered digital signal from the digital signal and generate the pre-processed signal.

In accordance with any embodiments of the present disclosure, the pre-processor is further configured to select a length of a moving widow for the median filter in accordance with a pulse width of a transmitted light pulse.

In accordance with any embodiments of the present disclosure, the length of the moving widow is longer than the pulse width of the transmitted light pulse.

In accordance with any embodiments of the present disclosure, the threshold technique is an analog threshold technique.

In accordance with any embodiments of the present disclosure, the threshold technique is constant false alarm rate (CFAR) threshold technique.

In accordance with any embodiments of the present disclosure, the processor is further configured to analyze a cell-under-test (CUT) and M reference cells in accordance with the number of reference cells M and the multiplication factor K₀ to detect the presence of the object.

In accordance with a second broad aspect of the present disclosure, there is provided a method for object detection comprising: receiving, a light signal reflected from an object; converting, the received light signal into a digital signal; pre-processing, the digital signal based on median filtering and generating a pre-processed signal corresponding to the digital signal; and analyzing, the pre-processed signal based on a threshold technique and detecting a presence of the object.

In accordance with any embodiments of the present disclosure, the pre-processing comprises: median filtering the digital signal and generating a filtered digital signal; and subtracting the filtered digital signal from the digital signal and generating the pre-processed signal.

In accordance with any embodiments of the present disclosure, the pre-processing further comprises selecting a length of a moving widow for a median filter in accordance with a pulse width of a transmitted light pulse.

In accordance with any embodiments of the present disclosure, the length of the moving widow is longer than the pulse width of the transmitted light pulse.

In accordance with any embodiments of the present disclosure, the threshold technique is an analog threshold technique.

In accordance with any embodiments of the present disclosure, the threshold technique is constant false alarm rate (CFAR) threshold technique.

In accordance with any embodiments of the present disclosure, the processing further comprises analyzing a cell-under-test (CUT) and M reference cells in accordance with the number of reference cells M and the multiplication factor K₀ to detect the presence of the object.

### BRIEF DESCRIPTION OF THE DRAWINGS

The features and advantages of the present disclosure will become apparent from the following detailed description, taken in combination with the appended drawings, in which:

FIG. 1 depicts a high-level functional block diagram of a LiDAR system, directed to detect an object, in accordance with various non-limiting embodiments of the present disclosure;

FIG. 2 illustrates a high-level functional block diagram of the receiver configured to detect the to detect one or more objects in the region of interest (ROI) and the associated distance from the LiDAR system, in accordance with various non-limiting embodiments of the present disclosure;

FIG. 3 illustrates a high-level functional block diagram of the digital converter in accordance with various non-limiting embodiments of the present disclosure;

FIG. 4 illustrates a LiDAR waveform corresponding to the reflected light signal y(t) under normal weather conditions, in accordance with various non-limiting embodiments of the present disclosure;

FIG. 5 illustrates LiDAR waveforms corresponding to the reflected light signal y(t) under normal adverse weather conditions;

FIG. 6 illustrates LiDAR waveforms corresponding to the reflected light signal y(t) for different scanning ranges of the LiDAR system;

FIG. 7 illustrates LiDAR waveforms corresponding to the reflected light signal y(t) for different scanning ranges of the LiDAR system on a log-scale;

FIG. 8 illustrates a high-level functional block diagram of the pre-processor, in accordance with various non-limiting embodiments of the present disclosure

FIG. 9 illustrates an example of an input to a median filter and the corresponding output, in accordance with various non-limiting embodiments of the present disclosure;

FIG. 10 illustrates LiDAR waveforms corresponding to the reflected light signal y(t), a filtered digital signal y′(n), and a pre-processed digital signal y″(n), in accordance with various non-limiting embodiments of the present disclosure;

FIG. 11 illustrates a high-level functional block diagram of the processor, in accordance with various embodiments of the present disclosure;

FIG. 12 illustrates LiDAR waveforms corresponding to a noisy reflected light signal y(t), a detected signal using only thresholding (CFAR) technique and an output of the median filter, in accordance with various non-limiting embodiments of the present disclosure;

FIG. 13 illustrates LiDAR waveforms corresponding to a pre-processed digital signal y″(n) and a detected signal using the thresholding (CFAR) technique, in accordance with various non-limiting embodiments of the present disclosure;

FIG. 14 illustrates LiDAR waveforms corresponding to the pre-processed digital signal y″(n) and the detected signal using the thresholding (CFAR) technique on the log-scale, in accordance with various non-limiting embodiments of the present disclosure;

FIG. 15 illustrates LiDAR waveforms corresponding to a noisy reflected light signal y(t) affected by interferences located at a same spot, a detected signal using only the thresholding (CFAR) technique and an output of the median filter, in accordance with various non-limiting embodiments of the present disclosure;

FIG. 16 illustrates LiDAR waveforms corresponding to a pre-processed digital signal y″(n) corresponding to the noisy reflected light signal y(t) affected by interferences located at the same spot and a detected signal using the thresholding (CFAR) technique, in accordance with various non-limiting embodiments of the present disclosure;

FIG. 17 illustrates LiDAR waveforms corresponding to a pre-processed digital signal y″(n) corresponding to the noisy reflected light signal y(t) affected by interferences located at the same spot and a detected signal using the thresholding (CFAR) technique on the log-scale, in accordance with various non-limiting embodiments of the present disclosure; and

FIG. 18 depicts a flowchart of a process representing a method for object detection, in accordance with various non-limiting embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

The instant disclosure is directed to address at least some of the deficiencies of the current technology. In particular, the instant disclosure describes a system and a method for object detection.

Unless otherwise defined or indicated by context, all technical and scientific terms used herein have the same meaning as commonly understood by one of ordinary skill in the art to which the described embodiments appertain.

Various representative embodiments of the described technology will be described more fully hereinafter with reference to the accompanying drawings, in which representative embodiments are shown. The present technology concept may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “controller”, “processor”, “pre-processor”, or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first processor” and “third processor” is not intended to imply any particular order, type, chronology, hierarchy or ranking (for example) of/between the processor, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

In the context of the present specification, when an element is referred to as being “associated with” another element, in certain embodiments, the two elements can be directly or indirectly linked, related, connected, coupled, the second element employs the first element, or the like without limiting the scope of the present disclosure.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, the instant disclosure is directed to address at least some of the deficiencies of the current technology. In particular, the instant disclosure describes a system and a method for object detection.

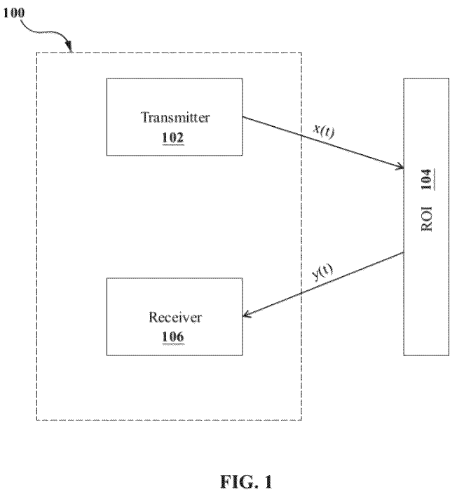

FIG. 1 depicts a high-level functional block diagram of LiDAR system 100, directed to detect an object, in accordance with the various non-limiting embodiments presented by the instant disclosure. As shown, the LiDAR system 100 may employ a transmitter 102 and a receiver 106. It will be understood that the LiDAR system 100 may include other elements but such elements have not been illustrated in FIG. 1 for the purpose of tractability and simplicity.

In certain non-limiting embodiments, the transmitter 102 may include a light source, for example, laser configured to emit light signals. The light source may be a laser such as a solid-state laser, laser diode, a high-power laser, or an alternative light source such as, a light emitting diode (LED)-based light source. In some (non-limiting) examples, the light source may be provided by Fabry-Perot laser diodes, a quantum well laser, a distributed Bragg reflector (DBR) laser, a distributed feedback (DFB) laser, and/or a vertical-cavity surface-emitting laser (VCSEL). In addition, the light source may be configured to emit light signals in differing formats, such as light pulses, continuous wave (CW), quasi-CW, etc.

In some non-limiting embodiments, the light source may include a laser diode configured to emit light at a wavelength between about 650 nm and 1150 nm. Alternatively, the light source may include a laser diode configured to emit light beams at a wavelength between about 800 nm and about 1000 nm, between about 850 nm and about 950 nm, between about 1300 nm and about 1600 nm or in any other suitable range known in the art for near-IR detection and ranging. Unless indicated otherwise, the term “about” with regard to a numeric value is defined as a variance of up to 10% with respect to the stated value.

The transmitter 102 may be configured to transmit light signal x(t) towards a region of interest (ROI) 104. The transmitted light signal x(t) may include one or more relevant operating parameters, such as: signal duration, signal angular dispersion, wavelength, instantaneous power, photon density at different distances from the light source, average power, signal power intensity, signal width, signal repetition rate, signal sequence, pulse duty cycle, wavelength, or phase, etc. The transmitted light signal x(t) may be unpolarized or randomly polarized, may have no specific or fixed polarization (e.g., the polarization may vary with time), or may have a particular polarization (e.g., linear polarization, elliptical polarization, or circular polarization).

It is contemplated that the ROI 104 area may have different objects located at some distance from the LiDAR system 100. At least some of the transmitted light signal x(t) may be reflected from one or more objects in the ROI. By reflected light, it is meant that at least a portion of the transmitted light signal x(t) reflects or bounces off the one or more objects within the ROI. The transmitted light signal x(t) may have one or more parameters such as: time-of-flight (i.e., time from emission until detection), instantaneous power (e.g., power signature), average power across entire return pulse, and photon distribution/signal over return pulse period, etc.

In certain non-limiting embodiments, the reflected light signal y(t) may be received by the receiver 106. The receiver 106 may be configured to process the reflected light signal y(t) to determine and/or detect one or more objects in the ROI 104 and the associated distance from the LiDAR system 100. It is contemplated that the receiver 106 may be configured to analyze one or more characteristics of the reflected light signal y(t) to determine one or more objects such as the distance downrange from the LiDAR system 100.

By way of example, the receiver 106 may be configured to determine a “time-of-flight” value from the reflected light signal y(t) based on timing information associated with: (i) when the light signal x(t) was emitted by the transmitter 102; and (ii) when the reflected light signal y(t) was detected or received by the receiver 106. For example, assuming that the LiDAR system 100 determines a time-of-light value “T” representing, in a sense, a “round-trip” time for the transmitted light signal x(t) to travel from the LiDAR system 100 to the object and back to the LiDAR system 100. As a result, the receiver 106 may be configured to determine the distance in accordance with the following equation:

$$R = \frac{c * T}{2} \qquad ( 1 )$$

wherein R is the distance, T is the time-of-flight value, and c is the speed of light (approximately 3.0×10⁸ m/s).

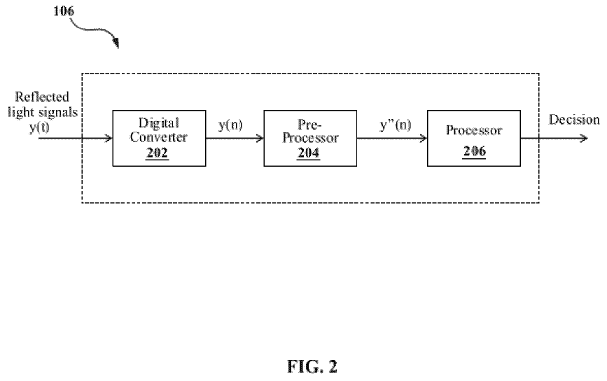

FIG. 2 illustrates a high-level functional block diagram of the receiver 106 configured to detect one or more objects in the ROI 104 and the associated distance from the LiDAR system 100, in accordance with various non-limiting embodiments of the present disclosure. As shown, the receiver 106 may include a digital converter 202, a pre-processor 204, and a processor 206. It is contemplated that the receiver 106 may include other elements but such elements have not been illustrated in FIG. 2 for the purpose of tractability and simplicity.

In certain non-limiting embodiments, the receiver 106 may receive the reflected light signal y(t). The receiver 106 may forward the reflected light signal y(t) to the digital convertor 202 for further processing. The digital converter 202 may be configured to convert the reflected light signal y(t) into a digital signal y(n). To do so, the digital converter 202 may convert the reflected light signal y(t) into an electrical signal and then into a digital signal y(n).

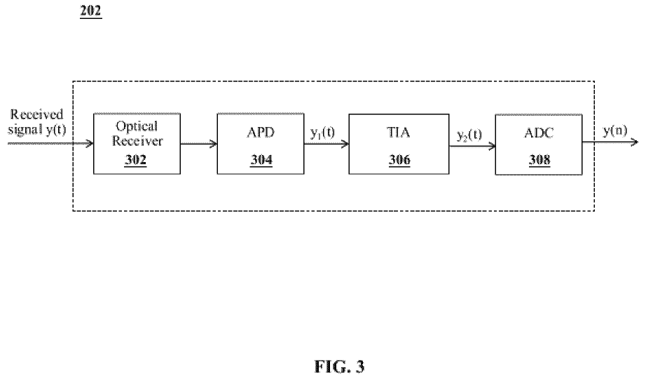

FIG. 3 illustrates a high-level functional block diagram of the digital converter 202 in accordance with various non-limiting embodiments of the present disclosure. As shown, the digital converter 202 may employ an optical receiver 302, an avalanche photo diode (APD) 304, a trans-impedance amplifier (TIA) 306, and an analog-to-digital converter (ADC) 308. It will be understood that other elements may be present but are not illustrated for the purpose of tractability and simplicity.

The optical receiver 302 may be configured to receive the reflected light signal y(t) reflected from one or more objects in the vicinity of the LiDAR system 100. The reflected light signal y(t) may then be forwarded to the APD 304. The APD 304 may be configured to convert the reflected light signal y(t) into electrical signal y₁(t) and supply the electrical signal y₁(t) to the TIA 306. The TIA 306 may be configured to amplify the electrical signal y₁(t) and provides the amplified electrical signal y₂(t) to the ADC 308. Finally, the ADC 308 may be configured to convert the amplified electrical signal y₂(t) into a digital signal y(n), corresponding to the received the reflected light signal y(t) and supplies the digital signal y(n) to the pre-processor 204 (as shown in FIG. 2) for further processing.

The digital signal y(n) may subsequently be supplied to the pre-processor 204 in order to remove noise or other impairments from the digital signal y(n) and generate a pre-processed digital signal y″(n).

The pre-processor 204 may then forward the pre-processed digital signal y″(n) to processor 206. The processor 206 may be configured to process the pre-processed digital signal y″(n) to detect the presence of objects in the vicinity of the LiDAR system 100. How the processor 206 processes the pre-processed digital signal y″(n) should not limit the scope of the present disclosure. Some of the non-limiting techniques related to the functionality of the processor 206 will be discussed later in the disclosure.

In certain scenarios, the weather conditions around the LiDAR system 100 may be considered to be normal, in which the power of the reflected light signal y(t) may be represented as:

$${P}_{r}^{clear} = \frac{{A}_{r} {η}_{t} {η}_{r}}{{R}^{2}} ρ {P}_{T} \qquad ( 2 )$$

Where, ηᵣ is the transmittance of the receiver 106 (known constant), ηₜ is the transmittance of the transmitter 102 (known constant), ρ is object's reflectivity (Typical value of ρ is 0.1), Aᵣ is the area of the receiver 106 (known constant), R is the distance of the object from the receiver 106 (estimated from the timing of every sample in the reflected light signal y(t)) and P_{T} is the power of the transmitted light signal x(n) (known value).

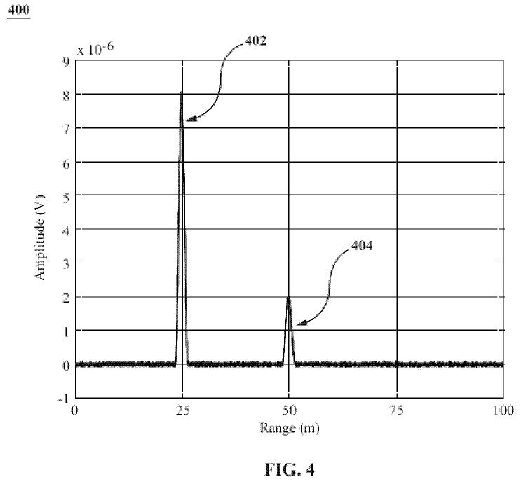

FIG. 4 illustrates a LiDAR waveform 400 corresponding to the reflected light signal y(t) under normal weather conditions, in accordance with various non-limiting embodiments of the present disclosure. The normal weather conditions may be referred to as clear weather conditions without any rain, fog, snow, or the like. The returned power Pᵣ^{clear} of the reflected light signal y(t) may be inversely proportional with distance squared, and linearly proportional with the object's reflectivity and the transmitted power. As shown, pulse 402 may represent a light signal reflected from an object closer to the LiDAR system 100 and pulse 404 may represent a light signal reflected from an object located at a longer distance. Accordingly, the amplitude of pulse 402 may be larger than pulse 404.

In other scenarios, the weather conditions around the LiDAR system 100 may be adverse. In such scenarios, the power of the reflected light signal y(t) may be represented as:

$${P}_{r}^{awc} ( R ) = exp ( - 2 {μ}_{ext} R ) {P}_{r}^{clear} ( R ) + conv ( {P}_{T} , H ( R ) ) \qquad ( 3 )$$

Where, Pᵣ^{awc}(R) represents the power of the light signal y(t) reflected from an object at range R during adverse weather conditions, μₑₓₜ represents an extinction coefficient, H(R) represents the channel spatial response at range R. The channel response H(R) may be represented as:

$$H ( R ) = {H}_{C} ( R ) β ( R ) \qquad ( 4 )$$

Where, β(R) may be a backscattering coefficient, H_{C}(R) may be an impulse response of optical channel at range R represented as:

$${H}_{C} ( R ) = {A}_{r} {η}_{t} {η}_{r} \frac{exp ( - 2 {μ}_{ext} R )}{{R}^{2}} ζ ( R ) \qquad ( 5 )$$

Where, ζ(R) may be a crossover function ratio between the area illuminated by the transmitter 102 and the area observed by the receiver 106 represented as:

$$ζ ( R ) = \{ \begin{matrix}0 , & R < {R}_{1} \\ \frac{R - {R}_{1}}{{R}_{2} - {R}_{1}} , & {R}_{1} \leq R < {R}_{2} \\ 1 , & R \geq {R}_{2}\end{matrix} \qquad ( 6 )$$

The adverse weather conditions may encompass fog, rain, dust clouds, or the like. The adverse weather conditions are capable of degrading the performance of conventional LiDAR systems as well as introducing challenges to the conventional LiDAR systems, namely, severe signal attenuation at long ranges, and false alarms caused at short ranges. In this regard, referring to equation (2), severe signal attenuation, especially at long ranges, may be expressed as exp(−2μₑₓₜR) and false alarms caused by the adverse weather conditions at short ranges may be expressed as conv(P_{T},H_{fog}(R)).

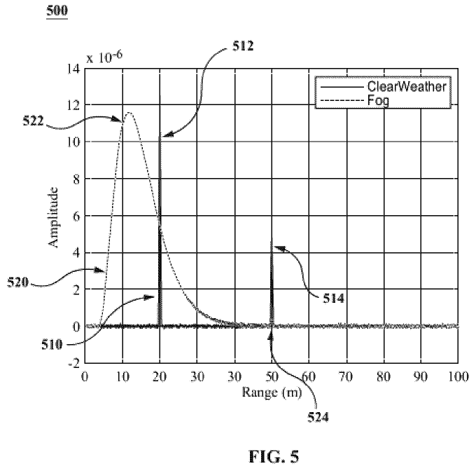

FIG. 5 illustrates LiDAR waveforms 500 corresponding to the reflected light signal y(t) under normal adverse weather conditions. The LiDAR waveforms 500 illustrate a LiDAR waveform 510 including reflected pulses 512 and 514 from the objects under normal weather conditions. Also, the LiDAR waveforms 500 illustrate a LIDAR waveform 520 including reflected pulses 522 and 524 from the objects under adverse weather conditions. As shown, the reflected pulse 522 (a short-range pulse) is wider as compared to the reflected pulse 512. Widening of the reflected pulse 522 may make it difficult for the processor 206 (as shown in FIG. 2) to accurately detect a location of the objects located closer to the LiDAR system 100. Also, the reflected pulse 524 (a long-range pulse) is severely attenuated as compared to the reflected pulse 514 may make it difficult for the processor 206 to accurately detect a location of the objects located farther from the LiDAR system 100.

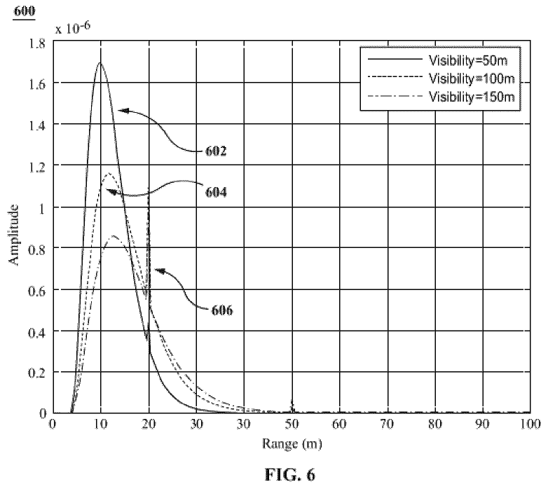

The effect of the adverse weather conditions may further exacerbate the performance of the LiDAR system 100 with an increase in the scanning range. FIG. 6 illustrates LiDAR waveforms 600 corresponding to the reflected light signal y(t) for different scanning ranges of the LiDAR system 100. The waveform 602 corresponds to the reflected light signal y(t) when the scanning range of the LiDAR system 100 was set to around 50 meters, the waveform 604 corresponds to the reflected light signal y(t) when the scanning range of the LiDAR system 100 was set to around 100 meters and the waveform 606 corresponds to the reflected light signal y(t) when the scanning range of the LiDAR system 100 was set to around 150 meters. As shown, the reflected pulses in the waveform 606 have been widened as compared to the reflected pulses in the waveforms 604 and 602.

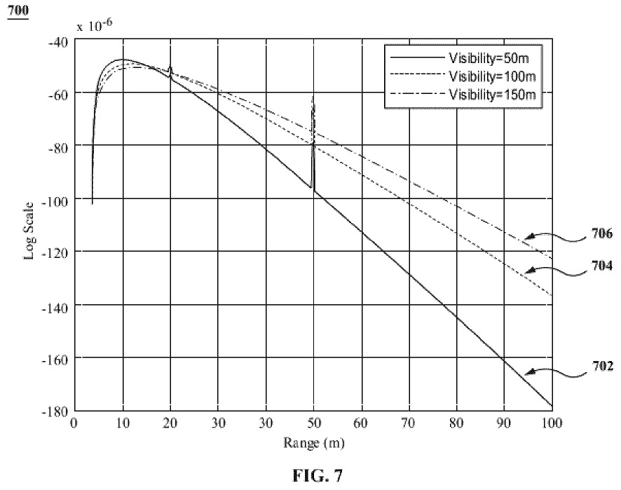

FIG. 7 illustrates LiDAR waveforms 700 corresponding to the reflected light signal y(t) for different scanning ranges of the LiDAR system 100 on a log-scale. The waveform 702 corresponds to the reflected light signal y(t) when the scanning range of the LiDAR system was set to around 50 meters, the waveform 704 corresponds to the reflected light signal y(t) when the scanning range of the LiDAR system was set to around 100 meters and the waveform 706 corresponds to the reflected light signal y(t) when the scanning range of the LiDAR system was set to around 150 meters.

It is to be noted, unless the reflected light signal y(t) is properly pre-processed, the conventional techniques, such as, for example, those based on analog threshold, cell average constant false alarm rate (CA-CFAR) threshold or the like may fail to detect the objects in the adverse weather conditions.

To this end, recently, few conventional techniques have been suggested to pre-process the reflected light signal y(t) in order to remove distortions due to the adverse weather conditions. These suggested techniques are based on fitting the reflected light signal y(t) to certain models. The restored reflected light signal y(t) is achieved by removing the fitted model from the reflected light signal y(t).

Some of the conventional pre-processing techniques are based on an expectation maximization to maximize the likelihood function of the undesired signal and the backscattering model. Some other conventional pre-processing techniques are based on Gamma model to fit the undesired effect of the adverse weather conditions. Some other conventional pre-processing techniques are based on fitting the backscattering return using the convolutional neural network (CNN). Such techniques may even require identifying adverse weather conditions prior pre-processing the reflected light signal y(t).

It is to be noted that the conventional pre-processing techniques suffer from the heavy computational load on the processors associated with the LiDAR system 100. Such conventional techniques may also require a large memory to buffer the reflected light signal y(t) prior to applying the fitting techniques. Moreover, some of the conventional pre-processing techniques may cause enormous errors if the adverse weather conditions are wrongly identified.

With this said, there is an interest in improving a performance of the LiDAR system 100 in the adverse weather conditions. To do so, certain non-limiting embodiments of the present disclosure may be based on computationally efficient pre-processing techniques, detail of which will be discussed in further in the present disclosure.

As previously discussed with respect to FIG. 2, the digital converter 202 may be configured to receive the reflected light signal y(t) and convert the reflected light signal y(t) to the digital signal y(n). The digital converter 202 may forward to the pre-processor 204 for pre-processing the digital signal y(n).

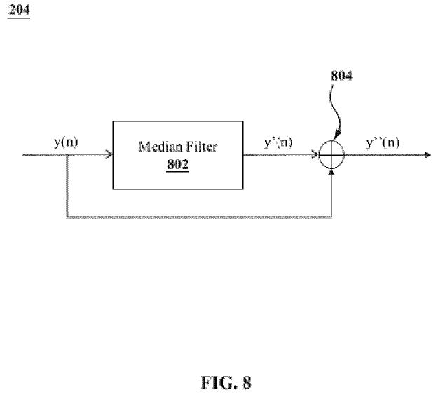

FIG. 8 illustrates a high-level functional block diagram of the pre-processor 204, in accordance with various non-limiting embodiments of the present disclosure. The pre-processor 204 may pre-process the digital signal y(n) based on median filtering and generate a pre-processed signal y″(n) corresponding to the digital signal y(n).

As shown, the pre-processor 204 may include a median filter 802 and a subtractor 804. It will be understood that the pre-processor 204 may include other elements but such elements have been omitted from the FIG. 8 for the purpose of tractability and simplicity.

It is to be noted that the digital signal y(n) may include a series of digital samples representing the reflected light signal y(t). Each digital sample in the digital signal y(n) may have a corresponding amplitude.

The median filter 802 may be configured to receive the digital signal y(n). The median filter 802 may be a non-linear filter in which each output sample may be computed as the median value of the input samples under the window. In other words, the output of the median filter may be a middle value of the input samples after the input samples values have been sorted.

In certain non-limiting embodiments of the present disclosure, performing median filtering based pre-processing of the reflected light signal y(t) may benefit from the fact that a width of the light pulses in the transmitted light signal x(t) may be smaller than a width of the light pulses in the reflected light signal y(t). To this end, the digital signal y(n) corresponding to the reflected light signal y(t) may be filtered out by using the median filter 802. The filtered digital signal represented as y′(n) may be subtracted from the digital signal y(n). In so doing, the effect of adverse weather conditions on the reflected light signal y(t) may be reduced significantly resulting in an improved performance of the LiDAR system 100. Additionally, the pre-processing based on median filtering may improve a performance of the pre-processor 204 by reducing a significant number of computations as compared to the conventional techniques.

In certain non-limiting embodiments, the median filter may select the digital samples from the digital signal y(n) in a sliding window manner. The length of the sliding window may depend on various operational parameters associated with the LiDAR system 100. Some of the non-limiting examples of the operational parameters may include a width of a light pulse in the transmitted light signal x(t), a sampling rate of the ADC 308 (as shown in FIG. 3) of the like. By way of example, if the width of the light pulse in the transmitted light signal x(t) is 5 ns and the sampling rate of the ADC 308 is 1 GHz, a minimum length of the sliding window may be equal to 5.

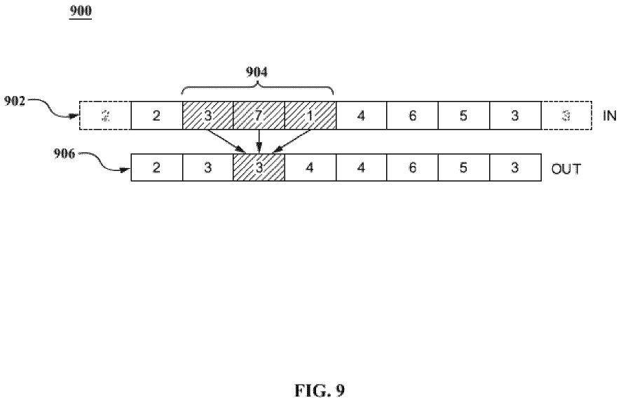

FIG. 9 illustrates an example 900 of an input 902 to the median filter 802 and the corresponding output 906, in accordance with various non-limiting embodiments of the present disclosure. As shown, the input 902 may include the digital samples in the digital signal y(n) having the corresponding amplitudes. A sliding window 904 may have, by way of non-limiting example, a length of 3. The median filter 802 may sort the digital samples in the sliding window 904 in either ascending or descending order of the corresponding amplitudes.

In case a number of digital samples in the sliding window 904 is odd, the median filter 802 may select a middle value from the sorted digital samples y(n). In case the number of digital samples in the sliding window 904 is even, the median filter 802 may select a middle pair values from the sorted digital samples y(n). The median filter 802 may average the middle pair values to determine the median value. The median filter 802 may slide the sliding widow 904 to the left or right, for example, by one unit. The median filter 802 may determine median values from the digital samples. The output 906 may represent the median values of the input 902.

Returning to FIG. 8, the output of the median filter 802 may be represented as filtered digital signal y′(n). The subtractor 804 may subtract the filtered digital signal y′(n) from the digital signal y(n) to reduce the effect of adverse weather conditions on the digital signal y(n). The resultant signal may be represented as pre-processed digital signal y″(n).

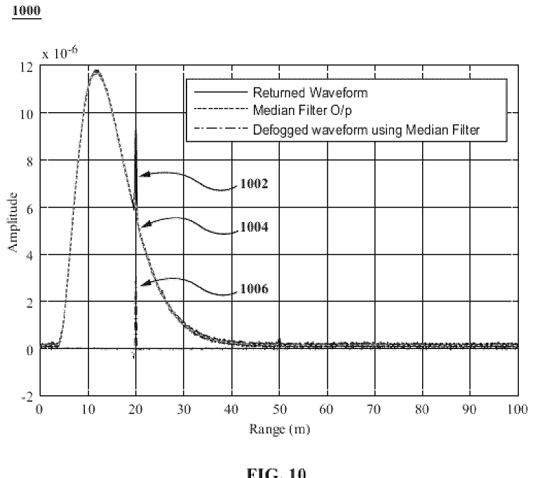

FIG. 10 illustrates LiDAR waveforms 1000 corresponding to the reflected light signal y(t) 1002, the filtered digital signal y′(n) 1004, and the pre-processed digital signal y″(n) 1006, in accordance with various non-limiting embodiments of the present disclosure. As shown, the effect of adverse weather conditions has been significantly reduced in the pre-processed digital signal y″(n) 1006.

Returning to FIG. 2, the pre-processor 204 may forward the pre-processed signal y″(n) to the processor 206. The processor 206 may determine a presence and location of the object with respect to the LiDAR system 100 based on a threshold technique. It is to be noted that the manner in which the processor determines the locations of the object should not limit the scope of the present disclosure.

Without limiting the scope of the present disclosure, in one embodiment, the determination of the presence and location of the object by the processor 206 may be based on analog threshold technique. In another embodiment, the determination of the presence and location of the object by the processor 206 may be based on constant false alarm rate (CFAR) threshold technique.

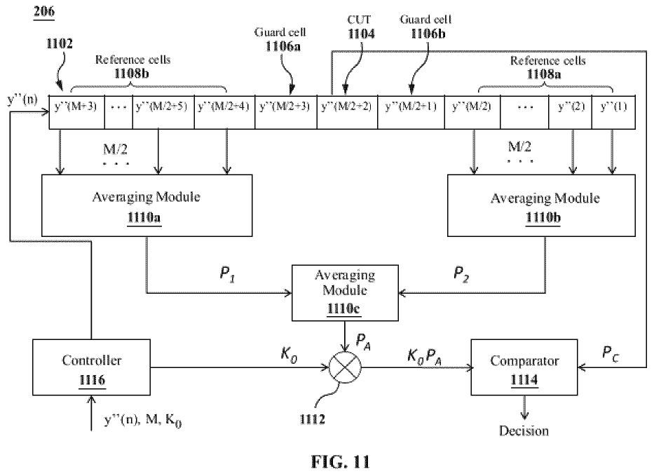

FIG. 11 illustrates a high-level functional block diagram of the processor 206, in accordance with non-limiting embodiments of the present disclosure. As shown, the processor 206 may employ a moving window 1102, averaging modules 1110a, 1110b, and 1110c, a mixer 1112, a comparator 1114 and a controller 1116. It will be understood that other elements may be present but are not illustrated for the purpose of tractability and simplicity.

The processor 206 may operate on a cell-under test (CUT) 1104 and M reference cells (1108a, and 1108b) around the CUT 1104, present in the pre-processed signal y′(n). In so doing, the processor 206 may compute an average power of M reference cells and multiplies the average power of M reference cells with a multiplication factor K₀ to calculate a threshold for object detection.

In certain non-limiting embodiments, the controller 1116 may be configured to receive the pre-processed digital signal y″(n) from the pre-processor 204. The controller 1116 may supply, for example, M+3 samples y″(1), y″(2), y″(3) . . . y″(M+3) in the pre-processed signal y″(n) to the moving window 1102. The moving window 1102 may be configured to temporarily store the M+3 samples y″(1), y″(2), y″(3) . . . y″(M+3) to be processed for object detection. In so doing, M/2 samples y″(1), y″(2), . . . y″(M/2) and M/2 samples y″(M/2+4), y″(M/2+5), . . . y″(M+3) may be reference cells 1108a and 1108b respectively, y″(M/2+1) and y″(M/2+3) may be guard cells 1106a and 1106b respectively, and y′ (M/2+2) may be CUT 1104. It will be appreciated that certain embodiments may have more than one guard cell on either side of CUT 1104.

The averaging modules 1110a and 1110b may be configured to compute average powers P₁ and P₂ corresponding to the reference cells 1108a and 1108b respectively. Further, the averaging modules 1110a and 1110b may supply the average powers P₁ and P₂ to the averaging module 1110c. The averaging module 1110c may be configured to compute an overall average power P_{A} of reference cells 1108a and 1108b by calculating a further average of average power P₁ and average power P₂ and may supply the computed average power P_{A} to the mixer 1112 for further processing.

The above mentioned operations of averaging modules 1110a, 1110b and 1110c are based on CA-CFAR however, it will be appreciated that averaging modules 1110a, 1110b and 1110c may be configured to operate on any suitable averaging techniques such as, for example, Smallest of Cell Averaging CFAR (SOCA-CFAR), or Greatest of Cell Averaging CFAR (GOCA-CFAR) etc. without departing from the principles discussed in the present disclosure.

The mixer 1112 may be configured to mix the average power P_{A} with the multiplication factor K₀ as supplied by the controller 1116 to generate a threshold K₀P_{A}. This threshold value K₀P_{A} may be supplied to the comparator 1114. The comparator 1114 may be configured to compare the power P_{C} corresponding to CUT 1104 with the threshold value K₀P_{A} as supplied by the mixer 1112. If the power P_{C} is greater than the threshold value K₀P_{A}, the object is detected.

It is to be noted that in addition the to improving the performance of the LiDAR system 100 under adverse weather conditions, the techniques discussed in the present disclosure may improve the performance of the LiDAR system 100 by suppressing internal and external interferences that have a different pulse width than the width of the light pulse in the transmitted light signal x(t).

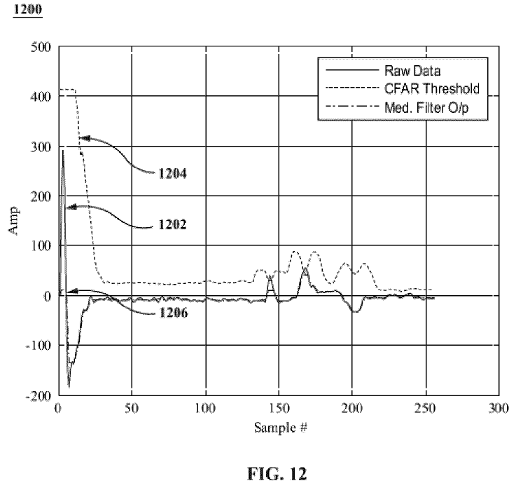

FIG. 12 illustrates LiDAR waveforms 1200 corresponding to a noisy reflected light signal y(t) 1202, a detected signal 1204 using only the thresholding (CFAR) technique and an output 1206 of the median filter, in accordance with various non-limiting embodiments of the present disclosure. It is to be noted that the noisy reflected light signal y(t) 1202 may be affected by the internal and/or external interferences. The signal 1204 may represent a signal detected based only on the CFAR thresholding technique. In other words, the noisy reflected light signal y(t) 1202 is detected and/or analyzed without any pre-processing technique. As shown, in the absence of any pre-processing, the CFAR thresholding technique may detect both the signal as well as the interference. The output 1206 may represent an output of the median filter 802 (as shown in FIG. 8).

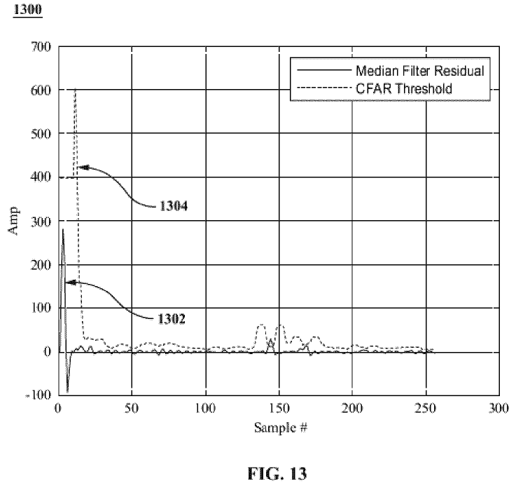

FIG. 13 illustrates LiDAR waveforms 1300 corresponding to a pre-processed digital signal y″(n) 1302 and a detected signal 1304 using the thresholding (CFAR) technique, in accordance with various non-limiting embodiments of the present disclosure. The pre-processed digital signal y″(n) 1302 may represent a residual signal from the median filter output (i.e., reflected light signal y(t) minus the median filter output). The signal 1304 may represent a signal detected by processing the pre-processed digital signal y″(n) 1302 based on the CFAR thresholding technique. In other words, the noisy reflected light signal y(t) 1202 is pre-processed to generate the pre-processed digital signal y″(n) 1302 and the signal 1302 is generated by processing the pre-processed digital signal y″(n) 1302. As shown, due to median filtering pre-processing, the CFAR thresholding technique may detects the signal with reduced interference.

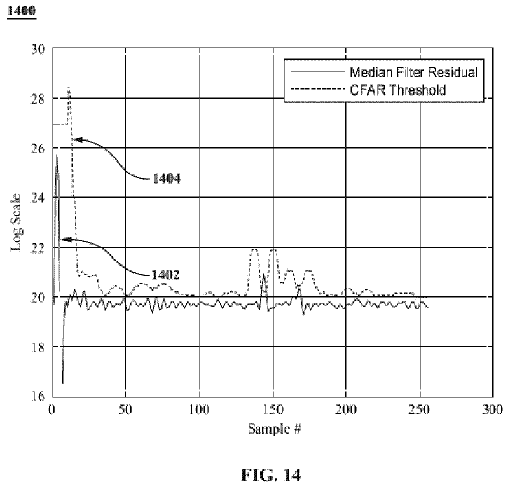

FIG. 14 illustrates LiDAR waveforms 1400 corresponding to a pre-processed digital signal y″(n) 1402 and a detected signal 1404 using the thresholding (CFAR) technique on the log-scale, in accordance with various non-limiting embodiments of the present disclosure.

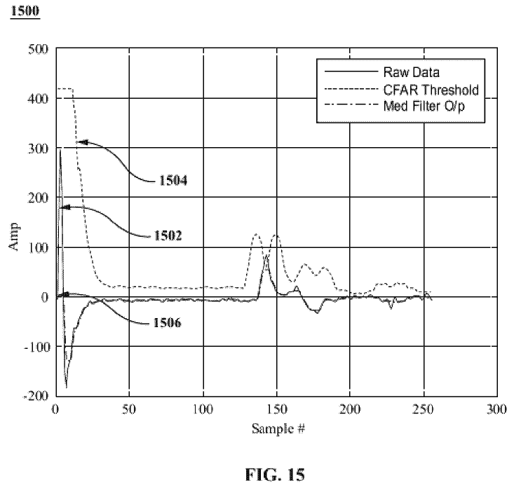

FIG. 15 illustrates LiDAR waveforms 1500 corresponding to a noisy reflected light signal y(t) 1502, a detected signal 1504 using only the thresholding (CFAR) technique and an output 1506 of the median filter, in accordance with various non-limiting embodiments of the present disclosure. It is to be noted that the noisy reflected light signal y(t) 1502 may be affected by the interferences located at the same spot. The signal 1504 may represent a signal detected based only on the CFAR thresholding technique. In other words, the noisy reflected light signal y(t) 1504 is detected and/or analyzed without any pre-processing technique. As shown, in the absence of any pre-processing, the CFAR thresholding technique may detect both the signal as well as the interference. The output 1506 may represent an output of the median filter 802 (as shown in FIG. 8).

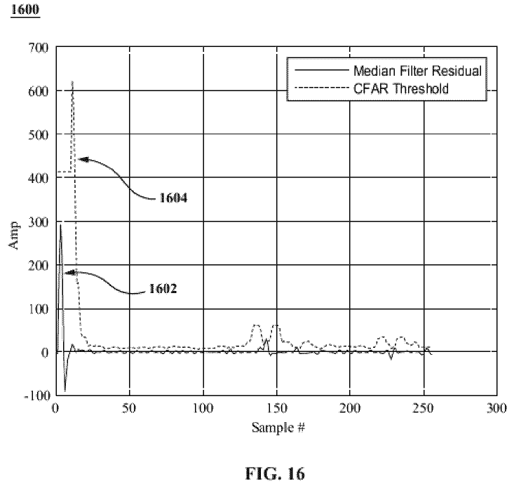

FIG. 16 illustrates LiDAR waveforms 1600 corresponding to a pre-processed digital signal y″(n) 1602 and a detected signal 1604 using the thresholding (CFAR) technique, in accordance with various non-limiting embodiments of the present disclosure. The pre-processed digital signal y″(n) 1602 may represent a residual signal from the median filter output (i.e., reflected light signal y(t) minus the median filter output). The signal 1604 may represent a signal detected by processing the pre-processed digital signal y″(n) 1602 based on the CFAR thresholding technique. In other words, the noisy reflected light signal y(t) 1502 is pre-processed to generate the pre-processed digital signal y″(n) 1602 and the signal 1602 is generated by processing the pre-processed digital signal y″(n) 1602. As shown, due to median filtering pre-processing, the CFAR thresholding technique may detect the signal with reduced interference, even though the noisy reflected light signal y(t) 1502 is subject to interference located at the same spot.

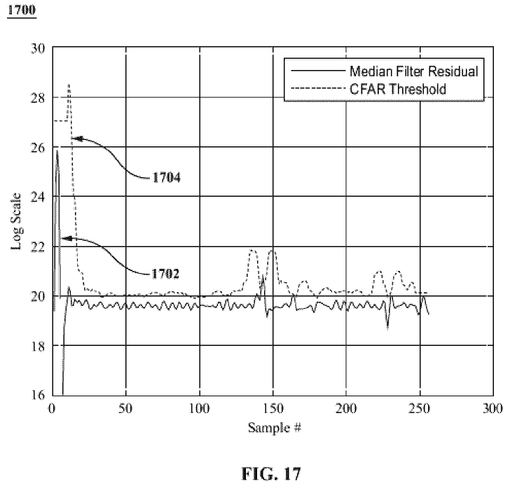

FIG. 17 illustrate LiDAR waveforms 1700 corresponding to a pre-processed digital signal y″(n) 1702 and a detected signal 1704 using the thresholding (CFAR) technique on the log-scale, in accordance with various non-limiting embodiments of the present disclosure.

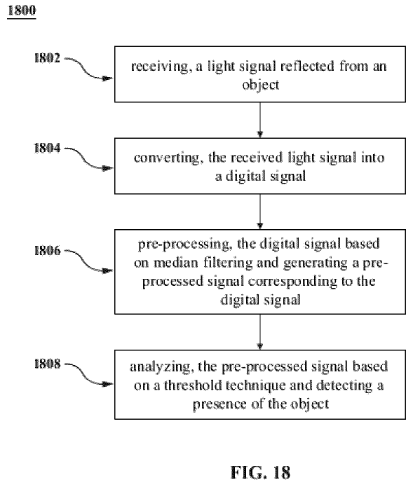

FIG. 18 depicts a flowchart of a process 1800 representing a method for object detection, in accordance with various non-limiting embodiments of the present disclosure. As shown, the process 1800 commences at step 1802 where a receiver receives a light signal reflected from an object. As previously noted, the receiver 106 is configured to receive the light signal y(t) reflected from the object 104.

The process 1800 advances to step 1804 where a digital converter converts the received light signal into a digital signal. As noted above regarding FIGS. 15 and 16, the digital convertor 202 is configured to convert the received light signal y(t) into the digital y(n).

The process 1800 proceeds to step 1806 where a pre-processor pre-processes the digital signal based on median filtering and generate a pre-processed signal corresponding to the digital signal. As previously noted, the pre-processor 204 is configured to pre-process the digital signal y(n) based on median filtering. The pre-processor 204 generates a pre-processed signal y″(n) corresponding to the digital signal y(n).

Finally, the process 1800 proceeds to step 1808 where a processor analyzes the pre-processed signal based on a threshold technique to detect a presence of the object. As noted previously, the processor 206 is configured to analyze the pre-processed signal y″(n) based on a threshold technique (e.g., analog threshold technique, CFAR threshold technique, or the like) to detect a presence of the object in the ROI 104.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A LiDAR system for object detection comprising:
a receiver configured to receive a light signal reflected from an object;
a digital converter configured to convert the received light signal into a digital signal;
a pre-processor configured to pre-process the digital signal based on median filtering and to generate a pre-processed signal corresponding to the digital signal; and
a processor configured to analyze the pre-processed signal based on a threshold technique to detect a presence of the object.

2. The LiDAR system of claim 1, wherein the pre-processor comprises:
a median filter configured to perform median filtering of the digital signal and generate a filtered digital signal; and
a subtractor configured to subtract the filtered digital signal from the digital signal and generate the pre-processed signal.

3. The LiDAR system of claim 2, wherein the pre-processor is further configured to select a length of a moving window for the median filter in accordance with a pulse width of a transmitted light pulse.

4. The LiDAR system of claim 3, wherein the length of the moving window is longer than the pulse width of the transmitted light pulse.

5. The LiDAR system of claim 1, wherein the threshold technique is an analog threshold technique.

6. The LiDAR system of claim 1, wherein the threshold technique is constant false alarm rate (CFAR) threshold technique.

7. The LiDAR system of claim 6 wherein the processor is further configured to analyze a cell-under-test (CUT) and M reference cells in accordance with the number of reference cells M and the multiplication factor K₀ to detect the presence of the object.

8. A method for object detection comprising:
receiving, a light signal reflected from an object;
converting, the received light signal into a digital signal;
pre-processing, the digital signal based on median filtering and generating a pre-processed signal corresponding to the digital signal; and
analyzing, the pre-processed signal based on a threshold technique and detecting a presence of the object.

9. The method of claim 8, wherein the pre-processing comprises:
median filtering the digital signal and generating a filtered digital signal; and
subtracting the filtered digital signal from the digital signal and generating the pre-processed signal.

10. The method of claim 9, wherein the pre-processing further comprises selecting a length of a moving window for a median filter in accordance with a pulse width of a transmitted light pulse.

11. The method of claim 10, wherein the length of the moving window is longer than the pulse width of the transmitted light pulse.

12. The method of claim 8, wherein the threshold technique is an analog threshold technique.

13. The method of claim 8, wherein the threshold technique is constant false alarm rate (CFAR) threshold technique.

14. The method of claim 13 wherein the processing further comprises analyzing a cell-under-test (CUT) and M reference cells in accordance with the number of reference cells M and the multiplication factor K₀ to detect the presence of the object.
